(19) United States
(12) Patent Application Publication
(10) Pub. No.: US 2003/0212745 A1
(43) Pub. Date: Nov. 13, 2003

(54) Selective multi-step email message marketing

(76) Inventor: David A. Caughey, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/140,056

(22) Filed: May 8, 2002

(51) Int. Cl. G06F 17/60; G06F 15/16

(52) U.S. Cl. 709/206; 705/14

(57) ABSTRACT

Here is disclosed a selective multi-step email message method for propagating same. A user interface allows the use of email messages for mass-advertisement while respecting private profiles of a receiving party. The method for automatically filtering email messages and allowing a recipient to pre-determine criteria according to interests for receiving multi-steps email messages. The interface allows the user to generate a propagating profile for use in automatically forwarding received multi-step email messages.

### FIELD OF THE INVENTION

The present invention relates generally to marketing using email message and more particularly to selective multi-step marketing respective of individual privacy and of in particular the laws of the United States of America.

### BACKGROUND OF THE INVENTION

By taking advantage of the growing popularity of the Internet, a user can send an electronic message to a receiving party located virtually anywhere in the world. Sending messages via electronic mail, or email messages, rather than using a conventional postal service offers many advantages, such as a considerable timesavings as well as cost savings. It may take only seconds for a message to be received by the receiving party located on the other side of the world. The receiving party has the option of: reading the message upon receipt directly on a computer screen, responding to it right away, saving it for later access or review, printing it, deleting it or forwarding it to another receiving party. Typically messages received by the receiving party are organized into convenient electronic folders and saved for as long as the receiving party wishes. Of course, since the message is electronic, less paper is consumed and therefore less space is occupied in filing cabinets. Due to these advantages, and others, email message has become a principal means of communicating for many individuals.

The rapid increase in the number of users of electronic mail and the low cost of distributing electronic messages, for example, via the Internet and other communications networks, has made mass marketing via email messages an attractive advertising medium. There is no rule that stops a user from creating a mass marketing electronic mailing list for use in sending advertising to hundreds or even thousands of parties at once. Due to the ease and cost of sending electronic mail to a very large number of recipients, the number of mass mailings for unsolicited email messages advertising has risen dramatically. Consequently, email message is now frequently used as the medium for widespread marketing broadcasts of unsolicited messages to email addresses, commonly known as spam mail.

Electronic mass marketers, also called spammers, use a variety of techniques for obtaining email address lists. For example, marketers obtain email addresses from postings on various Internet sites such as news group sites, chat room sites, or directory services sites, message board sites, mailing lists, and by identifying “mailto” address links provided on web pages. Using these and other similar methods, electronic mass marketers may effectively obtain large numbers of mailing addresses, which become targets for their advertisements and other unsolicited messages. Like some advertisements sent through the regular postal service, it is not necessarily clear to the recipient that the message is for advertising purposes until the recipient opens and reads the message. Thus, the target of the unsolicited electronic commercial message must typically open the message, read a portion of it, and then, after determining it to be unwanted, delete the message. A party receiving several of these commercial messages easily spends valuable time, resources and mental aggravation dealing with these mass email messages.

Users of Internet services and electronic mail, however, are not eager to have their email boxes filled with unsolicited email messages. This is an increasing problem for Internet service providers (ISPs) such as AOL™ or MSN™ and other entities with easily identifiable email addresses such as large corporations, for example IBMTM, MSN™, and General Motors™.

Companies and individuals in the business of mass commercial emailing have shown a reluctance to stop their practice or refrain from contacting recipients who do not want to receive promotions. This business, like traditional junk mail, is profitable. Since the cost of sending email messages is so low, the junk e-mailer, the spammer, benefits by contacting the largest and broadest group of recipients as possible—more recipients means more people who might be interested in a product or service advertised in the message—even if it also means a larger group of outraged recipients.

Members of the electronic community have tried to create numerous roadblocks to stop spamming—some electronic, some legal, and some with a business focus. Unfortunately, the junk email messages sending community has generally adapted to and overcome each one. An attempt to request the advertiser to stop soliciting the user is typically severely hindered since it is common practice for advertisers to either not provide a reply address, to make up a false reply address, or to use another false email address for relaying of the spamming electronic messages. Since some email systems, as for example the Internet, do not require a valid reply address or a valid sender name, most spam email messages can be repeatedly sent to thousands of people without giving the recipients, or receiving party, a convenient method to request that they be taken off the advertiser's list. Spammers who do provide valid reply information are often unresponsive to requests to desist. Accordingly, thousands of email users must filter through a barrage of unwanted email message advertisements, which typically must be opened in order to determine that it is an unwanted advertisement. Moreover, in order to be taken off the advertiser's list, the advertiser provides only a non toll-free number; therefore, the user must pay for a phone call, which may be long distance for stopping receipt of the junk email messages that he has never requested.

There is currently an attempt to address these issues of unsolicited commercial messages by legislative means. However, since it is relatively simple for an advertiser to access a server virtually anywhere in the world in order to send his unsolicited commercial message to anywhere else in the world, legislation in various countries, and in particular the US legislation, may have, at best, a limited effect on the problem.

The principal objection to junk mail is that it is theft of an organization's resources, such as time spent by employees to open each message, classify the message as legitimate vs. junk, and delete the message in dependence thereon. Another objection to junk mail is that it is frequently used to advertise fraudulent, dangerous, or objectionable content, such as pornography or to propagate financial scams such as illegal pyramid schemes.

As previously stated, the use of email messages for advertising is greatly advantageous over the use of the regular postal services because of the rapidity of message delivery and the reduced cost of sending to thousands of recipients. Further, even spammers have legitimate target customers or else they would cease spamming since it would provide them no benefit. The Internet is a tool that is ubiquitously used and should remain the same. However, the existence of spammers that use Internet for unselectively and enforcedly sending junk email messages enhances the need for a system that allows the use of email messages for advertising such that the advertising is performed on the Internet while respecting the receiving parties criteria for receiving advertisements through email messages.

### OBJECT OF THE INVENTION

It is therefore an object of the present invention to provide a system that allows the use of email messages for mass-advertisement while respecting private profiles of a receiving party.

It is another object of the present invention to provide a system for allowing a recipient to pre-determine criteria according to interests for receiving multi-steps email messages.

It is another object of the present invention to provide a system that allows the use of email message for mass-advertisement such that forwarding of the advertisement is performed through email contact lists provided by successive recipients.

### SUMMARY OF THE INVENTION

In accordance with a preferred embodiment of the preset invention, there is provided with a method of propagating an email message comprising the steps of:

providing an email message comprising:

a message content including text information for being read by the recipient,

contact data including at least an email address of a recipient, and

content data including data for indicating a domain of interest within which the message content falls and for being interpreted automatically by a process available for execution by the recipient to allow automated filtering of the email message in dependence thereon; and,

sending the email message in accordance with the contact data.

In accordance with another preferred embodiment of the present invention, there is provided a messaging system comprising a recipient interface for receiving a message for being transmitted via electronic mail, data relating to a domain of interest of the message, and at least an electronic address of a recipient for whom the message is destined, a processor for generating an email message destined for the recipient and including the message and having encoded therein, data other than text data relating to the domain of interest, the data for automated extraction by a process available for execution by the recipient for filtering of the email message in dependence upon the domain of interest indicated.

In accordance with another preferred embodiment of the present invention, there is provided a method of propagating an email message comprising the steps of: receiving an email message comprising content data, determining from a recipient user profile whether the content data is indicative of a domain of interest of the recipient for automatically forwarding email messages, when the content data is indicative of a domain of interest of the recipient, transmitting the email message to another recipient; and, when the content data is indicative of other than a domain of interest of the recipient other than transmitting the email message to the other recipient.

In accordance with another preferred embodiment of the present invention, there is provided a messaging system comprising:

a recipient interface for receiving and transmitting an email message having:

a message for being read by a recipient, and

a tag indicative of a content data of the message, the tag for being automatically deciphered by the recipient interface;

a storage medium for storing data indicative of domain of interests of the recipient and a forwarding profile; and,

a processor for upon receipt of an email message, automatically comparing the tag against at least one of the stored data indicative of domain of interests of the recipient and the forwarding profile to determine a comparison result and for one of automatically forwarding the email message and other than automatically forwarding the email message in dependence upon the comparison result;

when a result of the comparison indicates a match between the tag and the stored data indicative of domain of interests of the recipient, the email message is stored for provision to the recipient; and,

when a result of the comparison indicates other than a match between the tag and the stored data indicative of domain of interests of the recipient, the email message is other than stored for provision to the recipient.

In accordance with another preferred embodiment of the present invention, there is provided a messaging system comprising:

a recipient interface for receiving and transmitting an email message having:

a message for being read by a recipient, and

a tag indicative of a content data of the message, the tag for being automatically deciphered by the recipient interface;

a storage medium for storing data indicative of domain of interests of the recipient and a forwarding profile; and,

a processor for upon receipt of an email message, automatically comparing the tag against at least one of the stored data indicative of domain of interests of the recipient and the forwarding profile to determine a comparison result and for one of automatically forwarding the email message and other than automatically forwarding the email message in dependence upon the comparison result.

In accordance with another preferred embodiment of the present invention, there is provided a method of propagating an email message comprising the steps of:

receiving on a recipient system an email message comprising content data,

determining from a recipient user profile whether the content data is indicative of a domain of interest of the recipient,

when the content data is indicative of a domain of interest of the recipient, providing the email message to the recipient; and, when the content data is indicative of other than a domain of interest of the recipient other than providing the email message to the recipient.

In accordance with another preferred embodiment of the present invention, there is provided a messaging system comprising:

a recipient interface for receiving and transmitting an email message having

a message for being read by a recipient,

a tag other than a subject line of the email message and indicative of a content data of the message, the tag for being automatically deciphered by the recipient interface;

a storage medium for storing data indicative of domain of interests of the recipient;

a processor for upon receipt of an email message, automatically comparing the tag against the stored data indicative of domain of interests of the recipient; and,

when a result of the comparison indicates a match between the tag and the stored data indicative of domain of interests of the recipient, the email message is stored for provision to the recipient; and

when a result of the comparison indicates other than a match between the tag and the stored data indicative of domain of interests of the recipient, the email message is other than stored for provision to the recipient.

In accordance with another preferred embodiment of the present invention, there is provided a method of propagating an email message comprising the steps of:

providing a message including data encoded therein indicative of a domain of interest for a product, the data encoded for detection by a known process;

transmitting the message to at least a known recipient;

providing to the at least a known recipient an option of exercising control over domains of interest within which to automatically forward email messages; and

automatically forwarding of the message by a system of the at least a known recipient and absent intervention by the at least a known recipient to other recipients, the forwarding performed in dependence upon the encoded data and data indicative of recipients known to the at least a known recipient.

### BRIEF DESCRIPTION OF THE DRAWINGS

Exemplary embodiments of the invention will now be described in conjunction with the following drawings, in which:

FIG. 1 is a prior art illustration of uncontrolled mass-advertisement email message;

FIG. 2a is an example of an applet which presents various fields of interest presented for selection upon individual criteria;

FIG. 2b is a detailed item of a field of interest extracted form FIG. 2a;

FIG. 3 shows a main characteristic of the applet;

FIG. 4a is a diagram corresponding to a method for selectively managing multi-step email messages;

FIG. 4b shows a structure of a multi-step email message;

FIG. 4c is a diagram corresponding to a method for distinguishing between a junk email message and a multi-step email message;

FIG. 5 is a diagram corresponding to a method of selectively receiving multi-steps email messages;

FIG. 6 is a diagram corresponding to a method of selectively forwarding multi-steps email messages; and,

FIG. 7 illustrates a recapitulative example of a path of a multi-step email message.

### DETAILED DESCRIPTION OF THE INVENTION

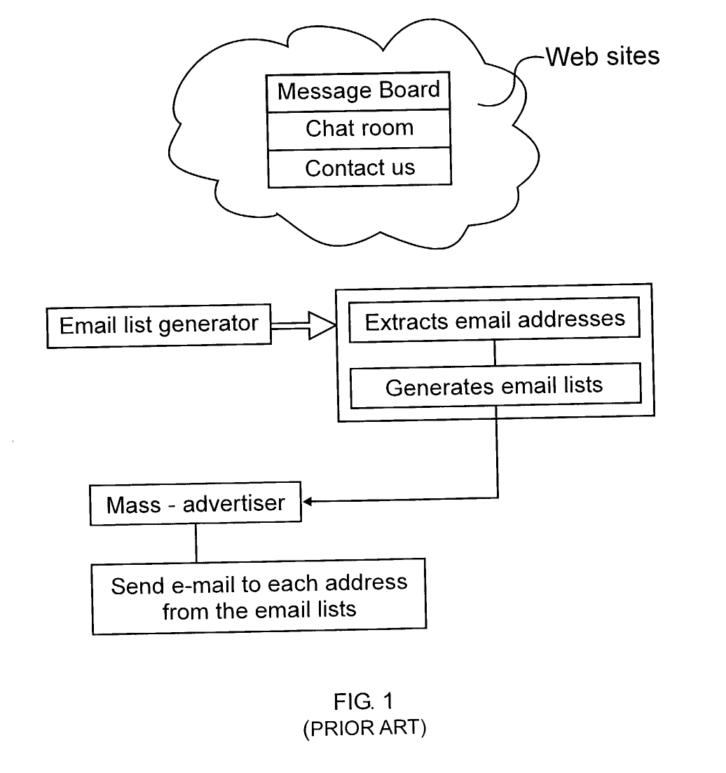

Referring to FIG. 1, a prior art method of establishing email address lists for sending mass-advertisement is shown. An advertiser, or a propagator, generates an email address list by extracting an email address from various types of web sites, in the form for example of message board sites, chat room sites, contact us or “mail to” sites and so forth. Alternatively the advertiser obtains a list of email addresses from a third party. In the prior art system, once the advertiser establishes a list, email messages are sent to each address without the consent of the recipients.

Some of the advertisers have no scruples and send mass-advertisement with no discrimination of the type of ads that is mass emailed to thousands of recipients, and these advertisers protect themselves from being traced. Furthermore, most of the people that use Internet and have email addresses are not computer specialists. Therefore, it is typically difficult as well as time consuming for a recipient to be removed off an email address list created by the advertisers.

Furthermore, should a recipient be successfully removed from the list of an advertiser, the recipient then receives no advertising email message from the advertiser, including messages of interest. This can be considered a loss for the recipient since they will not receive messages of interest. Similarly, through removal of the recipient from the list the advertiser has lost a potential client. Of course, likely the recipient's email address will be gathered by another advertiser such that spam is still received just from other advertisers.

It would therefore be a plus for advertisers to be able to selectively target their potential clients. Furthermore, it would be advantageous for potential clients, or recipients, to select the types of content they receive in the multi-step email messages. This is achieved by prompting a potential client, to download a selective multi-step email message process in the form of an applet for automatically filtering multi-step email messages or mass-email messages, wherein the applet allows the potential client to select domains of interest.

Should people be concerned to download such an application because of the risks of downloading viruses concurrently with the applet, for example, the applet is provided by a trusted party. This is verifiable, for example, using a certificate that is verified prior to downloading and installation of the applet.

Upon downloading the applet, the client is informed of substantially advantageous characteristics of the applet, as for example that the applet comprises a process for allowing the client to decide whether they wish to receive multi-step email messages according to their predetermined selection, if they agree, they select their areas of interest and whether they further are interested in becoming an intermediate in the propagation of the multi-step email messages.

Optionally, the clients choose whether or not they want to be part of the advertising path by selecting an option of forwarding the advertising email message to a selection of contacts from their email address list.

Optionally, upon choosing to be in the path, and upon a sale of a product having been advertised through his email address list, a client is financially rewarded in a predetermined manner, such as a pre-established percentage of goods sold as a result of their position within the advertising path.

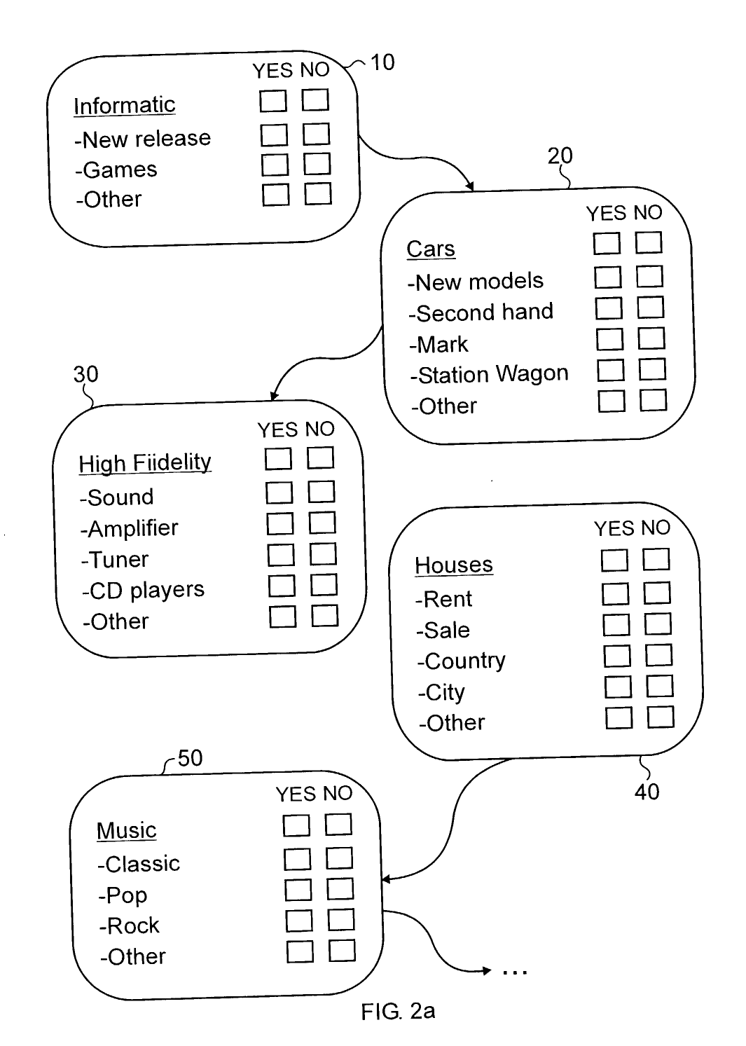

In reference to an aspect of the present invention, FIG. 2a illustrates an example of various options provided by the applet; the applet is a software application that offers a recipient the possibility of predetermining which advertiser domains of interest they wish to receive advertising messages. Of course, the applet is not limited to the few options shown in the figure. Furthermore, the applet is configurable by the recipient as a function of new options that appear on the market and hence options are added to the applet by the advertiser domains as newer products and services are added. The recipient then has the option of reviewing these newer products and services and determining whether they may be of potential interest by selecting them in the applet.

In the example shown in FIG. 2a, a first field 10 relates to informatics, as shown. A first option is to select whether this field 10 is of interest by selecting either one of YES and NO from the YES or NO box. If the answer is YES, a further selection is proposed to determine more specifically the area of interest of the client, for example “new releases”, “games”, or other informatics related domains. When the field 10 is completed, or if the answer in field 10 was NO, the client is directed toward the field 20 related to cars. Similarly, a first option is to select whether this field 20 is of interest by selecting the YES or NO box. If the answer is YES, a further selection is proposed to determine more specifically the area of interest of the client, for example “new models”, “second hand cars”, “marks”, “station wagon” or other car related domains. When the field 20 is completed, or if the answer in field 20 was NO, the client is directed toward the field 30 related to High Fidelity equipment. Similarly, a first option is to select whether this field 30 is of interest by selecting the YES or NO box. If the answer is YES, a further selection is proposed to determine more specifically the area of interest of the client, for example “sound”, “amplifiers”, “tuner”, “CD players” or other High Fidelity related domains. When the field 30 is completed, or if the answer in field 30 was NO, the client is directed toward the field 40 related to houses. Similarly, a first option is to select whether this field 40 is of interest by selecting the YES or NO box. If the answer is YES, a further selection is proposed to determine more specifically the area of interest of the client, for example “rent”, “sale”, “country”, “cities” or other houses related domains. When the field 40 is completed, or if the answer in field 40 was NO, the client is directed toward the field 50 related to music. Similarly, a first option is to select whether this field 50 is of interest by selecting the YES or NO box. If the answer is YES, a further selection is proposed to determine more specifically the area of interest of the client, for example “classic”, “pop”, “rock” or other houses related domains. Many other fields follow, as for example, a field for movies, a field for furniture, and a field for travel. There is substantially no limitation on the number or organization of the proposed fields.

Optionally, the fields are hierarchically organized from broader to narrower to eventually provide a user with only very specific advertising email message. FIG. 2b illustrates such an option. The field 30 of FIG. 2a related to High Fidelity equipment, where the “sound” option is more detailed in this example and some other possible selections are offered, for example “speakers”, “headphones”, “microphones”, or other audio and sound related domains.

In the present example, the hierarchical organization is in the form of a tree organization, similar to a unidirectional structure. However, a more complex hierarchical classification structure, i.e. a multidirectional classification is also used. For example when an individual is interested in second hands motor vehicles having a price lower than US $2.000, the different marks of cars, motorcycles, seadoos, skidoos and so forth are examined.

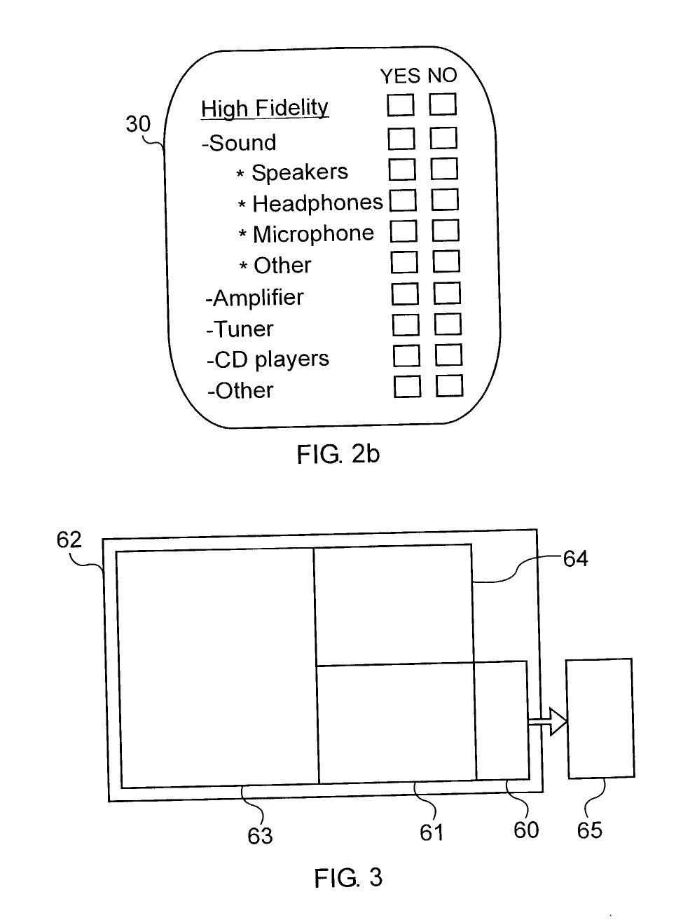

Referring to FIG. 3, a schematic representation of the selective multi-step email messages process or the applet is shown. The system comprises a recipient interface in the form of user interface 62 for providing data to a user and for receiving data from a user, a storage medium 64 for storing instruction data and a processor 63 for executing the instruction data in the form of generating private profiles corresponding to the interests of the user. The system comprises a propagating profile option 61 in the form of, for example, “forward current multi-step email message”, which is connected to a communication interface 60 for contacting an email address list 65 stored on the computer terminal of the user. Depending on the propagating profile of the user, a multi-step email message is automatically forwarded to each contact of the address list, to some of the contacts from the email address list, or none of the contacts. If the propagating profile indicates that multi-step email message are not to be forwarded to any contact from the email address list, the multi-step email message propagation does not continue from the system. When the profiles have been created, they are stored in the storage medium 64.

Advantageously, the generated profile is re-configurable by retrieving the stored generated profile and performing modifications, as for example if a pre-determined criterion was to not receive advertising for car sales and the user envisions buying a car in the near future, the pre-determined criterion is changed such that advertising regarding car sales is now selected, and as a result car sale ads are now presented to the user from the advertiser. Similarly, in the case of a change in the propagating profile, as for example an addition of new contacts to the address list, the profile is retrieved from the storage medium and the user modifies the propagating profile, as a function of the new contacts in the address list. Of course, typically the user first determines whether the new contacts added to the list want to partake in the multi-step email message process.

In use, when a user party receives a multi-step email message, in the form for example of an advertising email message, the email message is tagged and is automatically analyzed by the applet according to the generated profile of the recipient. Tagging the multi-step email message indicates to the receiving party that the multi-step email message has been processed by the applet. Furthermore, according to the propagating profile, the multi-step email message is selectively transmitted, or not, to a further recipient or a plurality of other recipients in dependence upon settings in the propagating profile.

Optionally, a multi-step email message sender or advertiser offers to any user aiding in the path of the multi-step email message propagation, a financial reward if a sale results from a final user as a result of the propagation of the multi-step email message along the chain of users. Therefore, the user's email address is automatically inserted in the multi-step email message such that the path from the original sender and the user who happens to buy an advertised product in the multi-step email message is accessible. Of course, it would be preferable to code the email addresses of the previous senders from which the email message originated in such a manner that a user does not simply insert their email address to prevent tampering with which users should receive the financial reward and to prevent disclosure of private information.

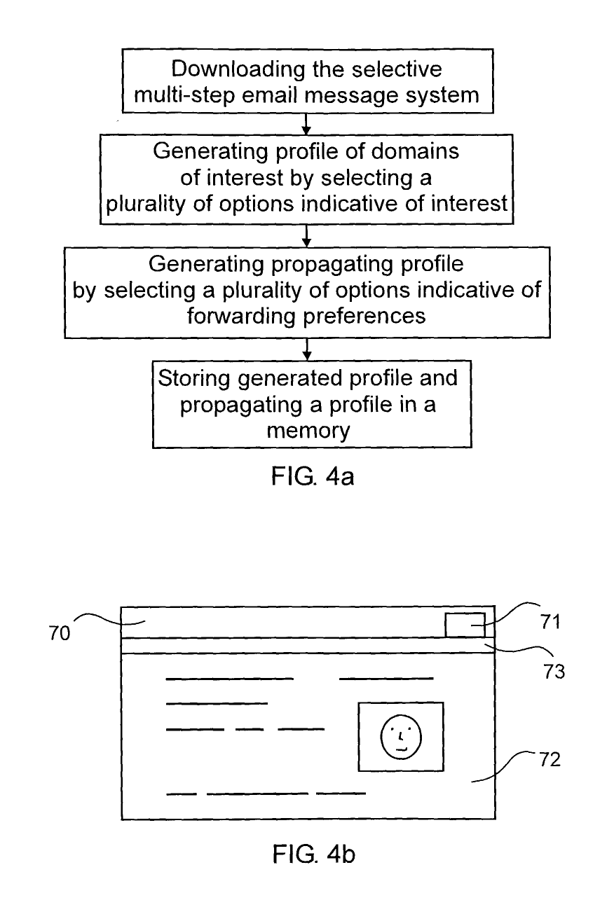

Referring to FIG. 4a, a diagram corresponding to a method for selectively managing multi-step email messages at a receiving party is shown. A user is prompted by a trusted provider to download a selective multi-step email messages system. When the system is downloaded, the user generates a profile corresponding to their domains of interest, as is illustrated in FIG. 2a. Similarly, a propagating profile is generated by selecting contacts from the user's email address list. Once a profile is generated, it is stored.

Of course, the options for generating the profiles are numerous as well as the possible combinations. For example, when a multi-step message concerns cars, a propagating profile is selected which restricts the propagation of the multi-step email message to a selection of contacts from the email address list. Similarly, when the multi-step message concerns High Fidelity equipment, a further propagating profile is selected to forward the multi-step email message to a further selection of contacts from the email address list. Of course, these further selections are performed automatically upon receipt of such email messages, where the applet facilitates the transmission of messages to other users in dependence upon the propagating profile. It will be apparent to those of skill in the art that the flexibility of the system and of the profile is related to design features and is determined based on design requirements, user needs, and implementation considerations.

Alternatively, the applet is provided by the advertiser with the email message the first time a multi-step email message is sent to each contact stored in their email address list. The diagram of FIG. 4b shows an example of a structure of a multi-step email message when an advertiser or a service provider for example, first sends a mass email message to each contact of their address book. The email message sent contains a window message 70 wherein the advertiser explains the content of this first contact multi-step email message. The explanation is in the form for example of a short letter saying:

“Dear customer, please, take the time necessary to read this message; it might save you time and frustration in the future by avoiding receipt of any further unwanted SPAM email messages.

How?

Just by downloading the attached applet, which is specifically designed to allow you to select your domains of interest (if any) in order to receive, if such is your choice, only email message corresponding to your preselected criteria.

Optionally, the window message is followed by another window containing a mass email message 72 directly accessible by the receiving party. Of course, the receiving party may choose not to download the applet and therefore continue to receive unwanted mass email messages.

Optionally, as part of the email message, the advertiser inserts a tag 73 in order to identify the content of a multi-step email message. The tag is in the form of a short title as for example: “big furniture sales” or “job announcements”. It is an advantageous option because a receiving party has a general idea of the content of a multi-step email message received. It is beneficial for a user to have an indication such that the user can react consequently. For example, if a tag in the form of a “big furniture sales” is displayed and the user is more interested at the moment in finding a new house, it will be easy to discard the multi-step email message received without opening it. Conversely, if a tag in the form of a “new houses on the market” is announced, the user will probably be more interested and save the message for future reading or even open the message as soon as it is received.

Optionally, as shown in the diagram of FIG. 4c, in order to have their advertising email messages processed by the applet, the advertisers are prompted to insert a tag within the multi-step email message such that it is recognized by the applet and treated as a multi-step email message when received by a receiving party. Therefore, multi-step email messages without a tag are not filtered or processed by the applet. Consequently, a receiving party is automatically aware that these email messages are most probably junk email messages and are discarded. As such, it is in the best interest of an advertiser or service provider to conform to such a prompt for increasing the chances of reaching select target people.

Optionally, each time an advertiser sends a new multi-step email message, the URL of the applet is attached to the new multi-step email message. Therefore, it is possible for a receiving party to choose once not to download the applet but to do so upon the receipt of a further multi-step email message.

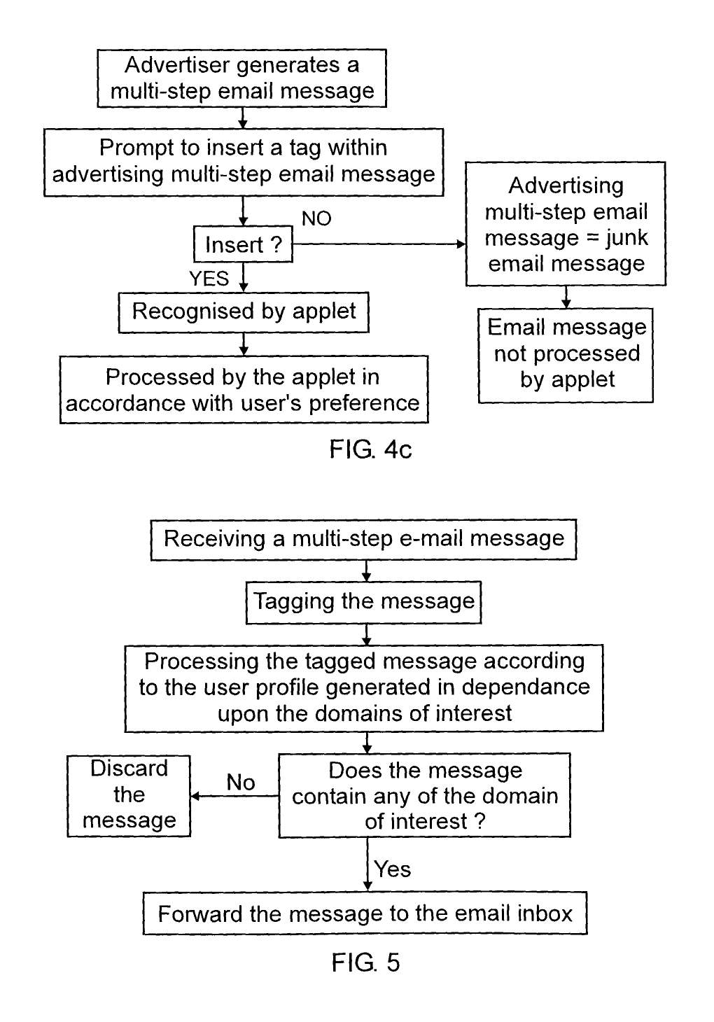

Referring now to FIG. 5, a diagram corresponding to a method of selectively receiving multi-step email messages is shown. Upon receipt of a multi-step email message, an operation is performed such that the multi-step email message is automatically tagged in order to be identified and processed as a multi-step email message. For example, the tagging may include another message attached thereto indicating data relating to a type of product or service being advertised. Alternatively, the tagging may be a link to a website or an applet for analysis by the multi-step email message applet.

Since there is a tag, inserted by the advertiser or inserted by the applet that has identified the email message as a multi-step email message, the tag can include an identifier such that the email message 101123876 from abc@def.com is only fully processed once by an applet regardless of how many times it is received; the remainder of identical email messages received are simply discarded by the applet.

That said, the multi-step email message is automatically filtered and processed according to the generated profile corresponding to areas of interests of the receiving party. In the case where the multi-step email message corresponds to any of the domains of interest, the message is automatically routed to the inbox of the receiving party for further reading. Conversely, if no domains of interest are detected during the processing of the multi-step email message, the message is discarded, the user being unaware of the existence of this message. Of course, a user may choose not to view any of the messages sent by the advertiser but may choose to forward them to those interested as determined by that users propagating profile in order to obtain a potential financial reward.

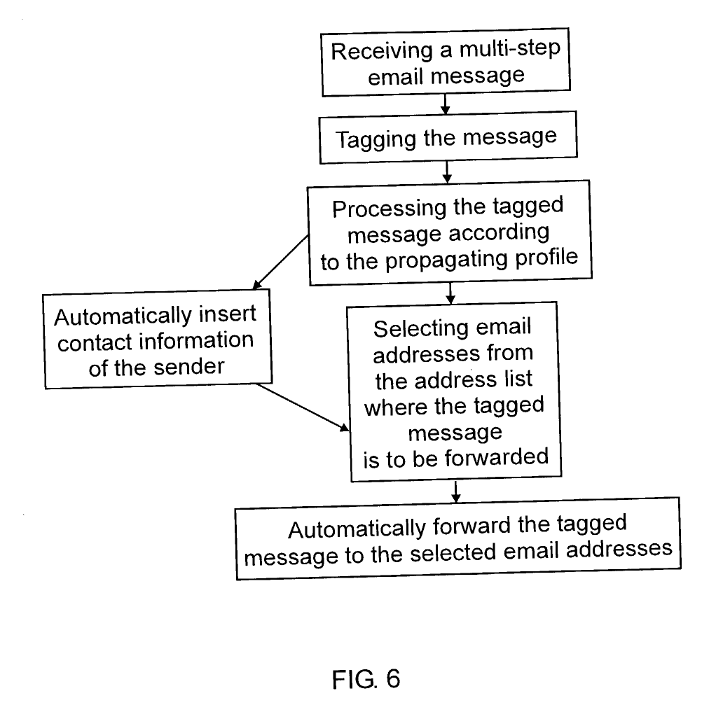

FIG. 6 is a diagram corresponding to a method of selectively forwarding multi-steps email messages. Upon receipt of a multi-step email message, an operation is performed such that the multi-step email message is automatically tagged in order to be identified and processed as a multi-step email message. The multi-step email message is automatically processed and forwarding according to the propagating profile of the user. The email address list is referenced by the applet such that the multi-step email message is sent to the selected contact from the email address list according to the propagating profile.

Optionally, upon receipt of a multi-step email message, or before automatically forward the multi-step email message, the email address of the user, which in this instance becomes a sender, is automatically inserted in the multi-step email message. Of course, if the sender does not want to be identified, he selects an anonymity option when generating his profile. However for remuneration purposes the email address of the sender is coded such that they can still benefit from potential financial gains.

Of course, notwithstanding that a message is discarded because no domains of interest have been detected during the processing of the multi-step email message, the multi-step email message is forwarded according to the user propagating profile.

Advantageously, if individual X is in the contact book of individual Y, the chances are that individual Y is in the contact book of individual X. Therefore, when X sends an email message in the form of a multi-step email message to Y, the chances are that the forwarding profile of X includes Y. However, since the multi-step email message is traceable, the email address of the email sender is automatically identified and compared against the propagating profile of the receiver such that an email message is preferably not forwarded to the party from which they are received.

Accordingly, as is apparent to a person with skill in the art, the forwarding profile varies from a simple profile to a more complex forwarding profile.

Remarkably, the selective multi-step email message system allows advertisers to contact thousands or millions of people, as many spammers do, without the disadvantages currently associated with spammers; advantageously recipients of advertising messages are contacted upon their consent. If for example a service provider sends a multi-step email message to thirty contacts stored in their email address list, and upon receipt of this email message by each of the thirty contacts, on the second step of the multi-step email message propagation, each of the thirty contacts forwards the email message to an average of another thirty further contacts, this means that the advertiser has indirectly targeted close to 900 recipients with their advertising message. In a third step, each of the 900 persons forward the email message to an average of thirty other further contacts, that means that 27,000 recipients have received the multi-step email message. On the fourth step, if a similar trend of propagation is maintained, 810,000 people would have been contacted, and so forth. Of course, in reality, some of the contact from each address list would refuse to receive or forward the message; some recipients might be contacted twice or more and so forth. However, almost a million people are potentially reachable while having their privacy maintained.

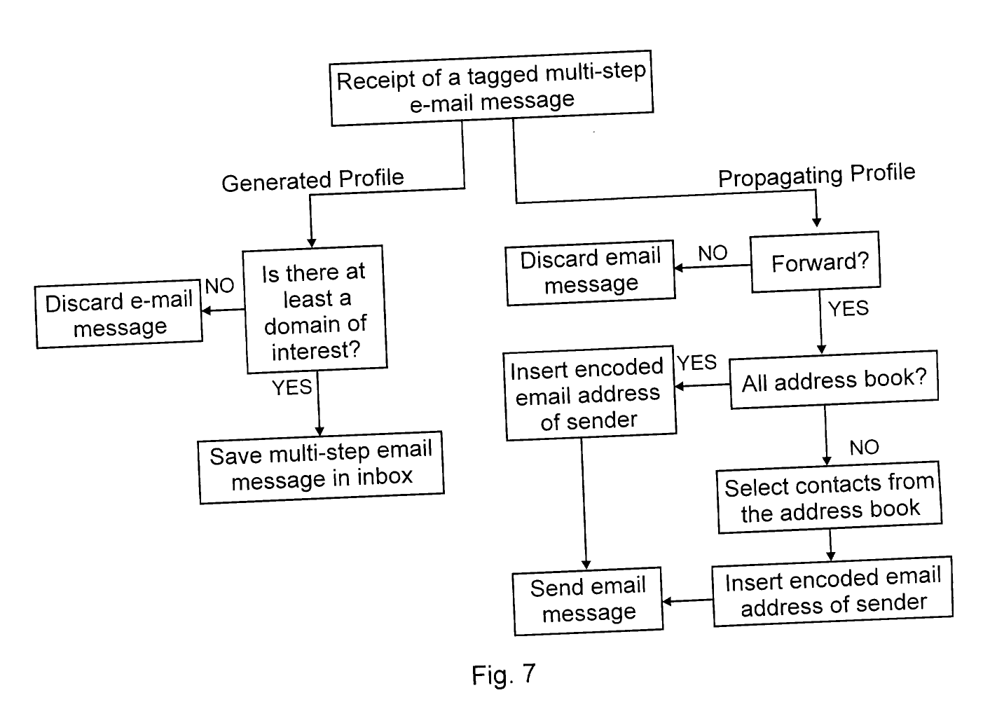

FIG. 7 shows a recapitulative example of a path of a multi-step email message when received by a user email server. A tagged multi-step email message is automatically processed by the applet that has been previously downloaded either provided by the advertiser himself or from a trusted party. The multi-step email message is analyzed according to the generated profile and it is first determined if the message contains any information related to a pre-determined domain of interest of the user. When no domain of interest is found, the multi-step email message is ignored; interestingly, the user is not aware the operation. Conversely, when information related to at least a domain of interest of the user is detected, the multi-step email message is saved and directed toward the email inbox of the user for future reading.

In parallel the multi-step email message is analyzed according to the forwarding profile. It is first determined if the message is to be forwarded. If the forwarding profile indicates no propagation of the multi-step email message, the message is ignored; interestingly, the user is not aware the operation. If the forwarding profile indicates no propagation of the multi-step email message and the email message other than relates to areas of interest, the message is discarded.

Conversely, when the forwarding profile indicates that the message is to be forwarded, it is determined to whom the message should be sent. If the user has selected all the contacts of the address book, the multi-step email message is sent to each contact. However, in order to trace the path of the multi-step email message between the advertiser and a potential buyer, the email address of the sender is automatically encoded and inserted in the email message before forwarding the email message. In a case the user has opted for forwarding multi-step email messages only to a selection of contacts from the address book, the message is forwarded accordingly. Here too, the email address of the sender is automatically encoded and inserted in the email message before forwarding thereof. Of course, the selected contacts might differ in dependence upon the content of the multi-step email message; the message is sent accordingly and the email address of the sender is automatically encoded and inserted in the email message before forwarding the email message. Of course, if the user has chosen not to partake in rewards or tracing within a forwarding chain, his email address is not automatically encoded and inserted in the multi-step email message.

According to such a path, when a user is interested in a service or any product advertised for example, he sends an order to the advertiser by a return email message wherein the chain of the different senders is accessible by the advertiser that possesses the decoding key for decoding the encoded email address of all the senders. Alternatively, a service provider receives the reply and arranges for processing of the order and for payment in accordance with some policy of the service provider. The use of a third party service provider allows for increased security against SPAM that masks itself to make use of the applet, supports payment if a financial reward is offered for forwarding and also increases security in that only the service provider need know how to decode each user identifier within a chain.

Numerous other embodiments may be envisaged without departing from the spirit or scope of the invention.

What is claimed is:

1. A method of propagating an email message comprising the steps of:
providing an email message comprising:
a message content including text information for being read by the recipient,
contact data including at least an email address of a recipient, and
content data including data for indicating a domain of interest within which the message content falls and for being interpreted automatically by a process available for execution by the recipient to allow automated filtering of the email message in dependence thereon; and,
sending the email message in accordance with the contact data.

2. A method of propagating an email message according to claim 1, wherein the content data is content data determined in accordance with a standard known set of content data for automatic interpretation by the process available for execution.

3. A method of propagating an email message according to claim 2, wherein the content data is content data uniquely identifies a domain of interest of the message content from a plurality of uniquely identifiable domains of interest.

4. A method of propagating an email message according to claim 2, wherein the content data is content data uniquely identifies a domain of interest within a hierarchical domain of interest classification structure.

5. A method of propagating an email message according to claim 2, wherein the content data is other than text data relating to the domain of interest.

6. A method of propagating an email message according to claim 1, including the step of: providing a list of domains of interest, the list of domains of interest provided to a user for selection therefrom;
selecting from the list of domains of interest a domain of interest for use in determining content data uniquely identifying a domain of interest; and
determining the content data from the selected domain of interest.

7. A method of propagating an email message according to claim 6, including the step of:
wherein the list of domains of interest includes a hierarchical list of domains of interest within a higher hierarchical domain of interest classification structure provided to a user for selection therefrom, and
wherein the content data is determined from the selected domain of interest and the classification structure.

8. A method of propagating an email message according to claim 6, wherein the contact data includes an identifier indicative of sender.

9. A method of propagating an email message according to claim 8, wherein the contact data includes email address of sender.

10. A method of propagating an email message according to claim 9, wherein the contact data includes data relating to a remuneration structure.

11. A method of propagating an email message according to claim 6, wherein the contact data includes an identifier indicative of sender, and wherein the contact data includes data relating to a remuneration structure.

12. A method of propagating an email message according to claim 1, including the step of:
inserting within the email message data indicative of a prompt, the prompt for prompting the recipient to download a recipient interface for generating a recipient user profile.

13. A messaging system comprising:
a recipient interface for receiving a message for being transmitted via electronic mail, data relating to a domain of interest of the message, and at least an electronic address of a recipient for whom the message is destined,
a processor for generating an email message destined for the recipient and including the message and having encoded therein, data other than text data relating to the domain of interest, the data for automated extraction by a process available for execution by the recipient for filtering of the email message in dependence upon the domain of interest indicated.

14. A method of propagating an email message comprising the steps of:
receiving an email message comprising content data,
determining from a recipient user profile whether the content data is indicative of a domain of interest of the recipient for automatically forwarding email messages,
when the content data is indicative of a domain of interest of the recipient, transmitting the email message to another recipient; and,
when the content data is indicative of other than a domain of interest of the recipient other than transmitting the email message to the other recipient.

15. A method of propagating an email message according to claim 14 wherein the step of transmitting the email message to another recipient comprises the step of inserting data indicative of an email address of the recipient.

16. A method of propagating an email message according to claim 15 wherein the step of inserting data indicative of an email address of the recipient comprises the step of encoding the email address of the recipient.

17. A method of propagating an email message according to claim 14 wherein the step of receiving an email message comprises the step of displaying within the email message a prompt for prompting the recipient to download a recipient interface for generating a recipient user profile.

18. A method of propagating an email message according to claim 17 wherein the step of displaying within the email message a prompt prompting the recipient to download a recipient interface comprises the step of providing a link for loading the recipient interface when not detected.

19. A method of propagating an email message according to claim 14 wherein the step automatically forwarding the email message comprises the step of automatically retrieving a recipient address list and forwarding the email message to at least one recipient address within the recipient address list.

20. A method of propagating an email message according to claim 19 wherein the step of automatically retrieving and forwarding comprises the steps of:
providing a recipient address list; and,
selecting at least a contact within the recipient address list to whom to forward the email message.

21. A messaging system comprising:
a recipient interface for receiving and transmitting an email message having:
a message for being read by a recipient, and
a tag indicative of a content data of the message, the tag for being automatically deciphered by the recipient interface;
a storage medium for storing data indicative of domain of interests of the recipient and a forwarding profile; and,
a processor for upon receipt of an email message, automatically comparing the tag against at least one of the stored data indicative of domain of interests of the recipient and the forwarding profile to determine a comparison result and for one of automatically forwarding the email message and other than automatically forwarding the email message in dependence upon the comparison result;
when a result of the comparison indicates a match between the tag and the stored data indicative of domain of interests of the recipient, the email message is stored for provision to the recipient; and,
when a result of the comparison indicates other than a match between the tag and the stored data indicative of domain of interests of the recipient, the email message is other than stored for provision to the recipient.

22. A messaging system according to claim 21, wherein the tag is other than a subject line of the message.

23. A messaging system according to claim 21, wherein the forwarding profile includes contact specific forwarding data relating to at least a selected contact within an address list of the recipient.

24. A messaging system comprising:
a recipient interface for receiving and transmitting an email message having:
a message for being read by a recipient, and
a tag indicative of a content data of the message, the tag for being automatically deciphered by the recipient interface;
a storage medium for storing data indicative of domain of interests of the recipient and a forwarding profile; and,
a processor for upon receipt of an email message, automatically comparing the tag against at least one of the stored data indicative of domain of interests of the recipient and the forwarding profile to determine a comparison result and for one of automatically forwarding the email message and other than automatically forwarding the email message in dependence upon the comparison result.

25. A messaging system according to claim 24, wherein the tag is other than a subject line of the message.

26. A messaging system according to claim 24, wherein the forwarding profile includes contact specific forwarding data relating to at least a selected contact within an address list of the recipient.

27. A method of propagating an email message comprising the steps of:
receiving on a recipient system an email message comprising content data,
determining from a recipient user profile whether the content data is indicative of a domain of interest of the recipient,
when the content data is indicative of a domain of interest of the recipient, providing the email message to the recipient; and,
when the content data is indicative of other than a domain of interest of the recipient other than providing the email message to the recipient.

28. A method of propagating an email message according to claim 27, wherein the step of receiving an email message comprises the step of providing an option to the recipient to load a recipient interface for generating a recipient user profile.

29. A method of propagating an email message according to claim 28, wherein the step of providing an option to the recipient comprises the step of providing a link for loading the recipient interface from an address on a public network when the interface is not detected in execution on the recipient system.

30. A method of propagating an email message according to claim 28, wherein the step of determining from a recipient user profile whether the content data is indicative of a domain of interest of the recipient comprises the step of retrieving the recipient user profile.

31. A method of propagating an email message according to claim 30, wherein the step of retrieving the recipient user profile comprises the step of providing a plurality of options for use in generating the recipient's preferences relating to domain of interests, the options provided via the recipient interface.

32. A method of propagating an email message according to claim 27, wherein the content data is content data determined in accordance with a standard known set of content data for automatic interpretation by a process available for execution.

33. A method of propagating an email message according to claim 32, wherein the content data is content data uniquely identifies a domain of interest of the message content from a plurality of uniquely identifiable domains of interest.

34. A method of propagating an email message according to claim 32, wherein the content data is content data uniquely identifies a domain of interest within a hierarchical domain of interest classification structure.

35. A method of propagating an email message according to claim 32, wherein the content data is other than text data relating to the domain of interest.

36. A method of propagating an email message according to claim 27, including the step of:
providing a list of domains of interest, the list of domains of interest provided to a user for selection therefrom;
selecting from the list of domains of interest a domain of interest for use in determining content data uniquely identifying a domain of interest; and
determining the content data from the selected domain of interest.

37. A method of propagating an email message according to claim 36, including the step of:
wherein the list of domains of interest includes a hierarchical list of domains of interest within a higher hierarchical domain of interest classification structure provided to a user for selection therefrom, and
wherein the content data is determined from the selected domain of interest and the classification structure.

38. A messaging system comprising:
a recipient interface for receiving and transmitting an email message having
a message for being read by a recipient,
a tag other than a subject line of the email message and indicative of a content data of the message, the tag for being automatically deciphered by the recipient interface;
a storage medium for storing data indicative of domain of interests of the recipient;
a processor for upon receipt of an email message, automatically comparing the tag against the stored data indicative of domain of interests of the recipient; and,
when a result of the comparison indicates a match between the tag and the stored data indicative of domain of interests of the recipient, the email message is stored for provision to the recipient; and
when a result of the comparison indicates other than a match between the tag and the stored data indicative of domain of interests of the recipient, the email message is other than stored for provision to the recipient.

39. A method of propagating an email message comprising the steps of:
providing a message including data encoded therein indicative of a domain of interest for a product, the data encoded for detection by a known process;
transmitting the message to at least a known recipient;
providing to the at least a known recipient an option of exercising control over domains of interest within which to automatically forward email messages; and
automatically forwarding of the message by a system of the at least a known recipient and absent intervention by the at least a known recipient to other recipients, the forwarding performed in dependence upon the encoded data and data indicative of recipients known to the at least a known recipient.
